(19) United States
(12) Patent Application Publication
(10) Pub. No.: US 2025/0388049 A1
(43) Pub. Date: Dec. 25, 2025

(54) WHEEL END SYSTEM

(71) Applicant: Consolidated Metco, Inc., Vancouver, WA (US)

(72) Inventors: Sven Torstveit, Vancouver, WA (US); Wesley Morris, Ridgefield, WA (US)

(21) Appl. No.: 19/244,272

(22) Filed: Jun. 20, 2025

Related U.S. Application Data
(60) Provisional application No. 63/662,019, filed on Jun. 20, 2024.

(51) Int. Cl. B60B 27/02; B60B 35/04

(52) U.S. Cl. CPC B60B 27/02; B60B 35/04; B60B 2380/75; B60B 2900/561

(57) ABSTRACT

In one aspect, a wheel end system is provided that includes a spindle having an interior and a side wall extending about the interior. The wheel end system further includes a wheel hub, inboard and outboard bearings rotatably connecting the wheel hub to the spindle, and a spacer between the inboard and outboard bearings. The spacer extends about the spindle and has a spacing between the spacer and the spindle. The side wall of the spindle has an airflow opening with an inlet portion that is outboard of the inboard bearing. The airflow opening is configured to permit air to travel from the spacing between the spacer and the spindle into the interior of the spindle.

### CROSS-REFERENCE TO RELATED APPLICATION

This application claims the benefit of U.S. Provisional Application No. 63/662,019, filed June 20, 2024, which is incorporated herein by reference in its entirety.

### TECHNICAL FIELD

This disclosure relates generally to wheel end systems for vehicles and, more specifically, to wheel end systems having vents to relieve air pressure within wheel hubs of the wheel end systems.

### BACKGROUND

Commercial vehicles, such as trailers pulled by tractors, typically have one or more axles and wheel hubs that rotatably connect wheels to the axles. The wheel hubs each have an interior with bearings, a lubricant such as oil or grease to lubricate the bearings, and one or more seals to limit egress of the lubricant from the interior of the wheel hub. The one or more seals also limit the ingress of water, dirt, and other debris into the interior of the wheel hub.

The interior of the wheel hub typically includes air in addition to the lubricant. During operation of the vehicle, the air in the interior of the wheel hub is heated by friction between components of the bearings as the bearing components move relative to one another. The air in the interior of the wheel hub may also be heated by, for example, an increase in ambient temperature and/or heat from a brake rotor connected to the wheel hub.

The heating of air in the interior of the wheel hub increases the air pressure within the interior of the wheel hub. Elevated air pressure within the wheel hub can damage the one or more seals of the wheel hub and shorten the lifespan of the wheel hub.

### BRIEF DESCRIPTION OF DRAWINGS

FIG. 1 is a perspective view of a wheel end system including a spindle, a wheel hub, and a generator;

FIG. 2 is a cross-sectional view taken along line 2-2 in FIG. 1 and showing the generator secured to an outboard end of the wheel hub;

FIG. 3 is an enlarged view of a portion of the wheel end system of FIG. 2 with an electrical and coolant harness extending in an interior of the spindle;

FIG. 4 is a view similar to FIG. 3 showing a direction of air flow along an air vent of the wheel end system that permits pressurized air to flow from an interior of the wheel hub to the interior of the spindle;

FIG. 5 is a perspective view of a spacer that may be used in a wheel end system having a tapered spindle like the wheel end system of FIG. 8;

FIG. 6 is a cross-sectional view taken across line 6-6 in FIG. 4 showing a notch of the spacer that permits air to travel into a spacing between an interior surface of the spacer and an outer surface of the spindle;

FIG. 7 is a cross-sectional view of another wheel hub system having a wheel hub mounted to a spindle and a hubcap secured to an outboard end of the wheel hub; and

FIG. 8 is a cross-sectional view of another wheel end system having a spindle with a tapered side wall and an airflow opening formed therein.

### DETAILED DESCRIPTION

In one aspect of the present disclosure, a wheel end system is provided that includes a spindle having an interior and a side wall extending about the interior. The wheel end system further includes a wheel hub, inboard and outboard bearings rotatably connecting the wheel hub to the spindle, and a spacer between the inboard and outboard bearings. The spacer extends about the spindle and has a radially extending spacing between the spacer and the spindle. The side wall of the spindle has an airflow opening with an inlet portion that is outboard of the inboard bearing. The airflow opening is configured to permit air to travel from the spacing between the spacer and the spindle into the interior of the spindle. In this manner, the airflow opening relieves or releases heated air from an interior of the wheel hub into the interior of the spindle to limit air pressure increases in the wheel hub that could damage one or more seals of the wheel hub.

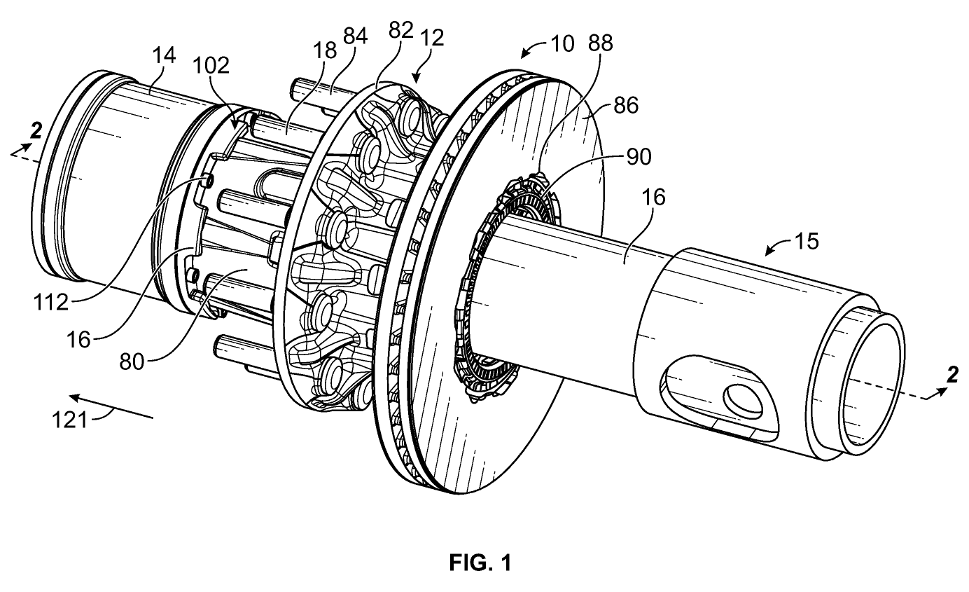

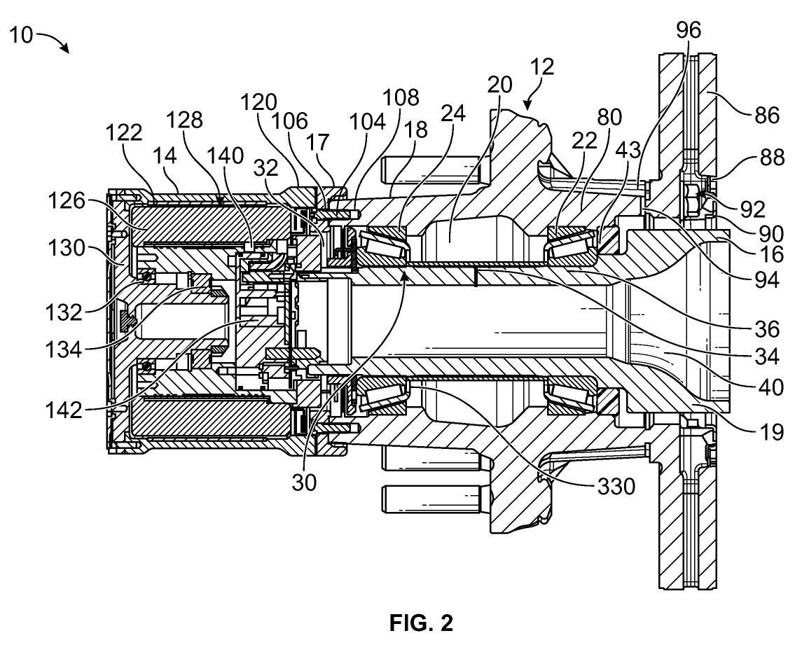

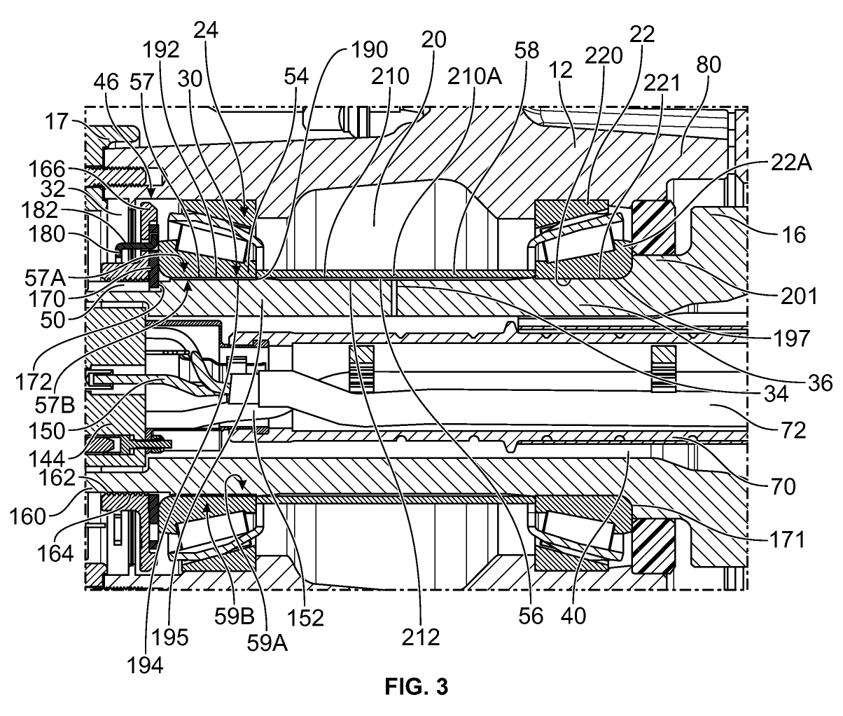

Regarding FIG. 1, a wheel end system 10 is provided that includes a wheel hub 12, a generator 14, and a parallel spindle 16 of an axle 15 of a vehicle. Regarding FIG. 2, the generator 14 is mounted via a mounting plate 17 to an outboard end portion 18 of the wheel hub 12. The wheel hub 12 has a cavity 20 between inboard and outboard bearings 22, 24 that receives a lubricant such as oil. The cavity 20 also contains air that is heated by the friction between the components of the inboard and outboard bearings 22, 24 as the wheel hub 12 rotates during operation of the vehicle as well as heat generated by friction on the brake rotor 86. The heated air may also travel into a cavity 32 (see FIG. 3) between a spindle nut assembly 46 and the generator 14.

The wheel end system 10 includes a vent 30 configured to permit heated air to flow from the cavities 20, 32 to an interior 40 of the spindle 16 to relieve air pressure within the wheel hub 12. In one embodiment, the interior 40 of the spindle 16 is vented to the atmosphere. By relieving air pressure within the wheel hub 12, the vent 30 inhibits an inboard seal 43 of the wheel hub 12 from being damaged by elevated air pressure in the wheel hub 12. The vent 30 includes an airflow passageway or airflow opening, such as opening 34, formed in a side wall 36 of the spindle 16. The opening 34 may be formed by machining, such as drilling, a hole in the side wall 36 of the spindle 16. The opening 34 is at an upper portion, such as a top dead center, of the spindle 16 to limit ingress of oil into the opening 34. In this manner, heated air can escape to the interior 40 of the spindle 16 while oil in cavities 20, 32 is kept out of the interior 40 of the spindle 16. In one embodiment, the spindle 16 has a body 19 with a unitary, one-piece construction that includes the side wall 36 and opening 34, the body 19 defining at least a portion of the interior 40.

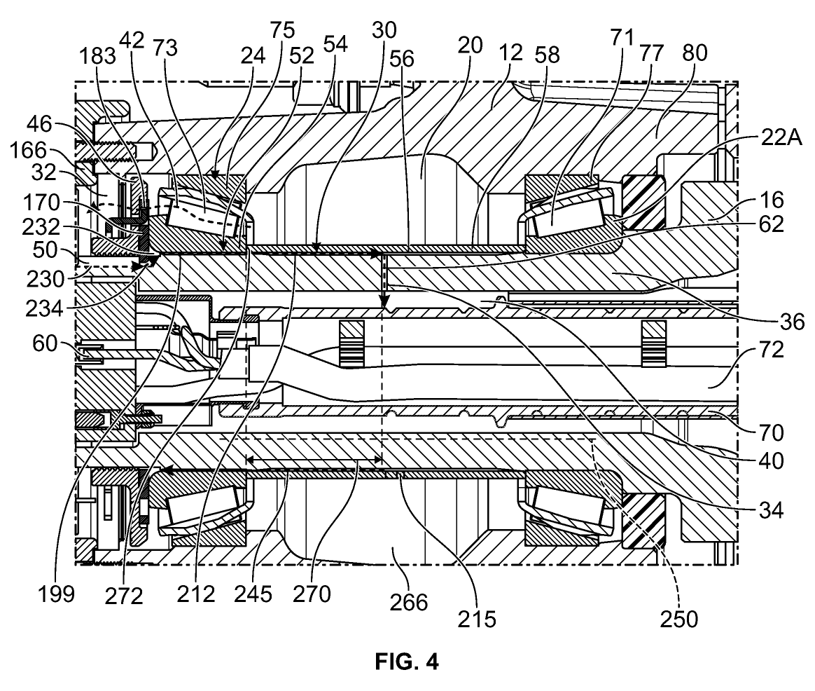

Regarding FIG. 4, in one embodiment the vent 30 includes a keyway 50 of the spindle 16, an annular cavity 232 between the spindle nut assembly 46 and the cone 54, an interface 52 between a cone 54 of the outboard bearing assembly 24 and the spindle 16, a spacing 56 between a spacer 58 and the spindle 16, and the opening 34 in the spindle side wall 36. In one embodiment, the interface 52 between the cone 54 and the spindle 16 is a bearing slip fit. In one embodiment, the spacing 56 includes a radial gap having a radial distance of 0.034 inches +/- 0.010 inches. In other embodiments, fewer or additional components may be used to form the vent 30. In FIG. 4, a sleeve 70 and electrical and coolant harness 72 for the generator 14 are shown that are not shown in FIG. 2 for clarity purposes.

Heated air in cavity 20 can flow in direction 42 through the outboard bearing assembly 24, through and around the spindle nut assembly 46, and into the cavity 32. Air in the cavity 32 can be heated by the friction between components of the outboard bearing assembly 24 and/or operation of the generator 14. The vent 30 permits air to travel from the cavity 32 in direction 230 along the keyway 50 axially inboard of the spindle nut assembly 46, in direction 234 in the annular cavity 232, in direction 199 through the interface 52 and spacing 56, in direction 62 along opening 34, and into the interior 40 of the spindle 16.

Returning to FIGS. 1 and 2, the wheel hub 12 has a wheel hub body 80 that may have a unitary, one-piece construction. The wheel hub body 80 has a wheel mounting portion such as a flange 82. The wheel hub 12 has studs 84 projecting therefrom to extend through openings on a wheel. The wheel end system 10 includes a brake rotor 86 having an opening 88 that receives an ABS tone ring 90 and fasteners 92, such as studs and nuts, for securing the brake rotor 86 to the wheel hub body 80. The wheel end system 10 includes a spacer 94 sandwiched between an inboard portion 96 of the wheel hub body 80 and the brake rotor 86 to resist heat transfer from the brake rotor 86 to the wheel hub body 80.

Regarding FIG. 1, the generator 14 is connected to an outboard end portion 18 of the wheel hub body 80 via a releasable connection 102. The releasable connection 102 includes radially inner bolts 104 (see FIG. 2) that extend through openings 106 of the mounting plate 17 and threadingly engage bores 108 of the outboard end portion 18 of the wheel hub body 80. The releasable connection 102 further includes radially outer bolts 112 (see FIG. 1) that secure the mounting plate 17 to a rotor 120 of the generator 14. In this manner, the generator 14 can be removed from the wheel hub body 19 by loosening the radially outer bolts 112 and shifting the rotor 120 in an outboard direction 121 away from the mounting plate 17 to, for example, permit removal of the spindle nut assembly 46 and wheel hub 12 from the spindle 16.

Regarding FIG. 2, the generator 14 includes magnets 122 of the rotor 120 that magnetically interact with a coil 126 of a stator 128 of the generator 14 as the rotor 120 rotates around the stator 128 to generate a flow of electricity in the coil 126. The generator 14 is thereby configured to generate electrical power upon rotation of the wheel hub 12 and the rotor 120 fixed thereto as the vehicle moves. In one embodiment, the wheel end system 10 is a component of a trailer that is towed behind a tractor and the generator 14 produces electricity for a component of the trailer such as a refrigeration system.

The rotor 120 includes a cover 130 that is rotatably connected to the stator 128 via bearings 132, 134. The cover 130 supports the rotor 120 to maintain a spacing having a predetermined radial distance between the magnets 122 of the rotor 120 and the coil 126 of the stator 128 as the rotor 120 rotates with the wheel hub body 80. The generator 14 has a power generation circuit 140 to control electrical power generation by the generator 14. The power generation circuit 140 provides electrical power to a female electrical and coolant interface 142 that releasably connects to a male electrical and coolant interface 144 (see FIG. 3) of the electrical and coolant harness 72. Upon connecting the interfaces 142, 144, electrical power may be provided to the vehicle and coolant may be provided to the generator 14 via electrical conduits 150 and coolant conduits 152.

Regarding FIG. 3, the spindle 16 has an outboard end portion 160 with threads 162 to engage threads 164 of a spindle nut 166 of the spindle nut assembly 46. The lock washer 170 of the spindle nut assembly 46 has a key portion 172 that extends into the keyway 50 of the spindle 16. The spindle nut assembly 46 further includes a locking member 180, such as a tab of the lock washer 170, that extends through an opening 182 of the spindle nut 166 and an opening 183 (see FIG. 4) of the lock washer 170. The locking member 180 inhibits turning of the spindle nut 166 relative to the lock washer 170 which keeps the spindle nut 166 secured to the spindle 16.

Regarding FIG. 3, the cone 54 of the outboard bearing assembly 24 has a central opening 190 with an annular, radially inner surface 192 extending thereabout and sized to fit over an annular, radially outer surface 194 of an outboard bearing journal 195 of the spindle 16. The inner and outer surfaces 192, 194 have a tolerance therebetween sized to provide the interface 52, which may include a bearing slip fit between the cone 54 and the spindle 16, therebetween that permits air to travel therethrough. The tolerance between the radially inner and outer surfaces 192, 194 is selected to permit air to travel between the cone 54 and the spindle 16 while providing a firm engagement of the cone 54 on the outboard bearing journal 195. More specifically, the weight of the vehicle urges the spindle 16 downwardly against the cone 54 and forms a small spacing 57 between upper portions 57A, 57B of the inner and outer surfaces 192, 194 while there is contact between lower portions 59A, 59B of the inner and outer surfaces 192, 194. Air may travel through the small spacing 57 between the upper portions 57A, 57B of the radially inner and outer surfaces 192, 194.

The spacer 58 maintains a predetermined axial distance between the cone 54 of the outboard bearing assembly 124 and a cone 22A of the inboard bearing assembly 22. The spindle nut 166 is tightened down with a high torque, such as 500 ft-Ibs or more, which causes the spindle nut assembly 46 to tightly engage the cones 54, 22A with the spacer 58 and urges the cone 22A against a stop surface 171 of the spindle 16. The tight engagement between the cones 54, 22A and spacer 58 inhibits air from traveling radially outward from the joints between the cones 54, 22A and spacer 58.

Regarding FIG. 3, the spacer 58 has a radially inner surface 210 spaced a radial distance from a radially outer surface 212 of the spindle 16 by the spacing 56. In one embodiment, the radially inner surface 210 has a portion 210A radially aligned with and spaced from the radially outer surface 212 of the spindle 16 at the opening 34. The radial distance of the spacing 56 is selected to provide sufficient clearance for air to flow into the opening 34 and permit oil to wick downward, around the radially outer surface 212 away from the opening 34. Oil that enters the gap 214 and travels to bottom of the spacer 58 may flow in outboard direction 245 (see FIG. 4) between the cone 54 and the spindle 16, through and around the spindle nut assembly 46, and into the cavity 32 and/or into the cavity 20. In one embodiment, the spacer 58 includes an opening 215 at a lower portion of the spacer 58 to permit oil to drain back into the cavity 20.

The inboard bearing journal 197 has an annular, radially outer surface 220 that receives the cone 22A of the inboard bearing assembly 22. The radially inner surfaces 192, 220 of the cones 54, 22A have similar inner diameters. The radially outer surface 220 of the inboard bearing journal 197 has a radially outer diameter that is similar to the radially outer surface 194 of the outboard bearing journal 195. The tolerance between radially inner and outer surfaces 221, 220 of the cone 22A and inboard bearing journal 197 is similar to the tolerance between the radially inner and outer surfaces 192, 194 of the cone 54 and outboard bearing journal 195.

In one embodiment, the cone 54 and outboard bearing journal 195 have a locational clearance fit such as a H6/h7 fit. For example, the tolerance between the radially inner and outer surfaces 192, 194 of the cone 54 and outboard bearing journal 195 may be 0.005 inches. The tolerance between the radially inner and outer surfaces 192, 194 is sized to permit air to travel between the cone 54 and outboard bearing journal 195.

In one embodiment, the cone 22A and the inboard bearing journal 197 have a locational clearance fit therebetween such as a H6/h7 fit. The tolerance between the radially inner and outer surfaces 221, 220 of the cone 22A and inboard bearing journal 197 may be 0.005 inches. The spacer 58 tightly engages a seal journal 201 and inhibits air that travels between the cone 22A and inboard bearing journal 197 from traveling inboard beyond the cone 22A.

Regarding FIG. 4, the wheel hub 12 may have an oil fill line 250 indicating an upper level of oil in the wheel hub 12 when the wheel hub 12 is at rest. The opening 34 is at an upper portion of the spindle 16. In this manner, oil that reaches the spacing 56 between the spacer 58 and the spindle 16 flows downwardly, around the outer surface 212 of the spindle 16 and away from the opening 34 under the effect of gravity.

Further, the opening 34 is a distance 270 away from an outboard end 272 of the spacer 58. The distance 270 is selected to provide a length along the outer surface 212 of the spindle 16 that oil can travel downwardly along and around as gravity draws the oil away from the opening 34. In one embodiment, the distance 270 is 5.299 inches and the opening 34 has an inner diameter of 0.0625 inches.

The distance 270 further decreases the likelihood of oil reaching the opening 34 since the oil would have to travel the distance 270 along the upper portion of the outer surface 212 of the spindle 16 against the pull of gravity. In one embodiment, the opening 34 is at top-dead center on the spindle 16 which makes it difficult for oil that reaches the spacing 56 to reach the opening 34 since gravity draws the oil downward away from the top of the spindle 16. When the vehicle is in motion, oil in the cavity 20 is urged radially outward against radially inner surfaces 266 of the wheel hub body 80 by rotation of the wheel hub body 80, roller bearings 71, 73, and cups 75, 77 and generally away from the vent 30.

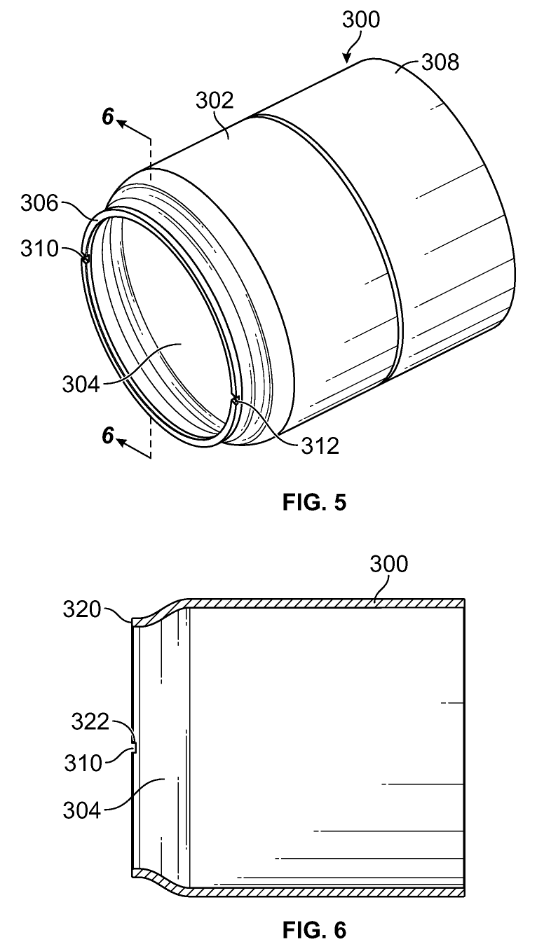

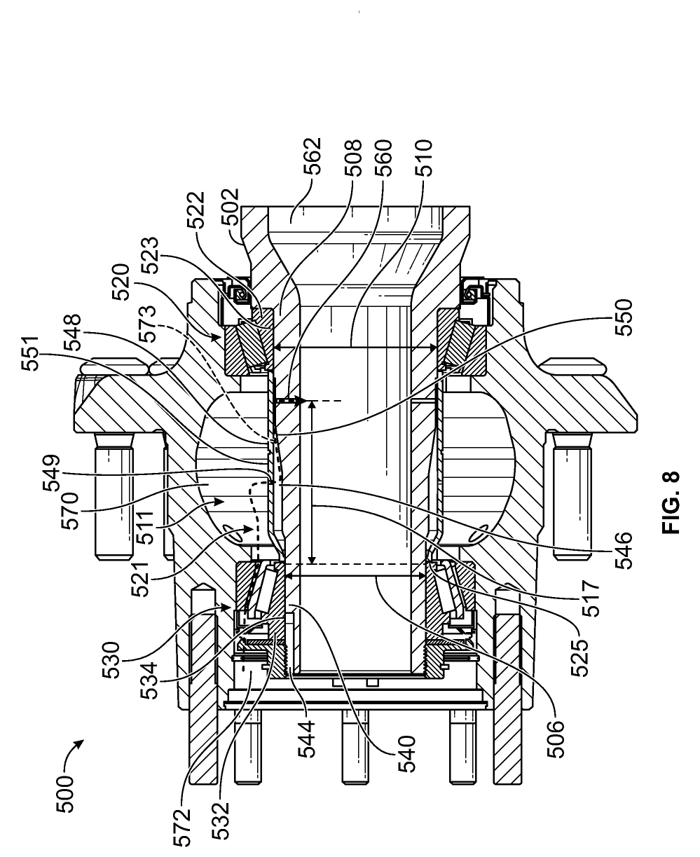

Regarding FIGS. 5 and 6, a spacer 300 is provided that may be used with a tapered spindle and wheel hub, such as spindle 502 and wheel hub 500 of FIG. 8. The spacer 300 has a spacer body 302 with a central opening 304. The spacer 300 has an outboard end portion 306 and an inboard end portion 308. The outboard end portion 306 includes one or more openings such as notches 310, 312. The notches 310, 312 permit air to enter into a spacing 546 (see FIG. 8) between the spacer 300 and a spindle 502. The tapered spindle 502 has an opening 560 that is spaced an axial distance 517 from an outboard bearing journal 540 of the spindle 502. The distance 517 provides an offset for the opening 560 from the outboard end portion 306 of the spacer 300 that is sized to permit any oil that enters the spacing 546 via notches 310, 312 to travel down around a tapered outer surface 550 of the spindle 502 and not enter the opening 560. The distance 517 for tapered spindles may be larger than the distance 270 for parallel spindles. For example, the distance 517 may be in the range of 0.5 inches to 4 inches, such as 0.7 inches or 3.7 inches.

In one embodiment, the notches 310, 312 are diametrically opposed on the outboard end portion 306 so that one of the notches 310, 312 is above the oil fill line 250 regardless of the rotary orientation of the spacer 300 on the spindle 502. This makes it easier for a technician to install the wheel hub 500 on the spindle 502 since the installer does not have to position the spacer 300 in a specific rotary orientation on the spindle 502 to facilitate operation of the opening 560. Further, oil that enters the spacing 546 can travel through the lower of the notches 310, 312 back into the cavity 570.

Regarding FIG. 6, the spacer 300 has an annular end surface 320 that is interrupted by the notches 310, 312. Each notch 310, 312 has a polygonal U-shape shape with straight edges 322, although other embodiments may have one or more curved edges. The annular end surface 320 abuts a flat annular surface 525 (see FIG. 8) of the cone 532 of the outboard bearing assembly 530.

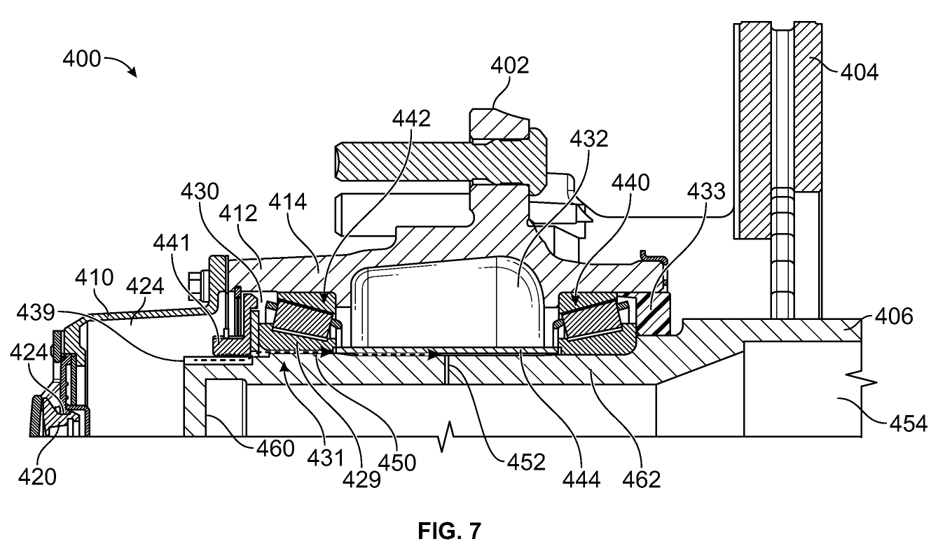

Regarding FIG. 7, wheel end system 400 is similar in many respects to the wheel end system 10 discussed above such that differences will be highlighted. The wheel end system 400 includes a wheel hub 402 with a brake rotor 404 connected thereto. The wheel hub 402 is rotatably mounted to a spindle 406. The wheel end system 400 has a hubcap 410 secured to an outboard end portion 412 of a wheel hub body 414 of the wheel hub 402.

The hubcap 410 has a plug 420 that closes an opening 422 of the hubcap 410. The plug 420 may be removed to permit a technician to add lubricant to a cavity 424 formed by the hubcap 410 and the wheel hub 402. The cavity 424 is in communication with cavities 430, 432 of the wheel hub 402. In this manner, the lubricant added to the cavity 424 may flow into contact with inboard and outboard bearing assemblies 440, 442.

The wheel hub 402 has a vent 431 to release or vent air that has been heated in the cavities 424, 430, 432 to protect a seal 433 of the wheel hub 402 from damage caused by pressurized air in the wheel hub 402. The vent 431 includes portions of a spindle keyway 439, spindle nut assembly 441, outboard cone 429, spacer 444, spindle 406, and an opening 452 of the spindle 406 that cooperate to provide a path for air to travel in direction 450 from cavity 424 to an interior 454 of the spindle 406. The spindle 406 has a closed end 460 that may be, for example, an end wall of the spindle 406, a cover, or a plug.

Regarding FIG. 8, the wheel hub 500 is similar in many respects to the wheel hubs discussed above. The wheel hub 500 is rotatably mounted to the spindle 502. The spindle 502 is a tapered spindle and has an outboard bearing journal 540 with a first outer diameter 506 and an inboard bearing journal 508 with a second outer diameter 510 that is larger than the first outer diameter 506. In one embodiment, the first outer diameter 506 of the outboard bearing journal 540 is 66.67 mm and the second outer diameter 510 of the inboard bearing journal 508 is 89.962 mm.

The wheel hub 500 has an inboard bearing assembly 520 that includes an inboard cone 522 with a central opening 523 having an inner diameter sized to permit the inboard cone 522 to fit onto the inboard bearing journal 508. The outboard cone 532 of the outboard bearing assembly 530 has a central opening 534 with an inner diameter sized to permit the outboard cone 532 to fit onto the outboard bearing journal 540. The tolerance between the outboard cone 532 and the outboard bearing journal 540 may be the same as the tolerance between the inboard cone 522 and the inboard bearing journal 508. For example, both the outboard cone 532 and the inboard cone 522 may have a clearance fit with the spindle 502. Air can vent from the cavity 570 into the spacing 546 between the spacer 548 and the spindle 502 via one or more openings 549 in a side wall 551 of the spacer 548. Similarly, if the spacer 300 is utilized with the wheel hub 500, one or more of the notches 310, 312 (see FIG. 5) permit air to vent from the cavity 570 into the spacing 546 between the spacer 300 and the spindle 502.

The wheel hub 500 has a vent 521 to vent air heated in an interior 511 of the wheel hub 500 to an interior 562 of the spindle 502 rather than increasing the air pressure in the interior 511 of the wheel hub 500. The vent 521 includes portions of a keyway 544, outboard bearing assembly 530, spindle 502, spacer 548 or spacer 300, and an opening 560 of the spindle 502 that cooperate to provide a path for air to travel from cavities 570, 572 of the wheel hub 500 to the interior 562 of the spindle 502. For example, air may travel in direction 573 from cavity 572, through openings of the outboard bearing assembly 530, into the cavity 570, through spacer opening 549, into spacing 546, and through the spindle opening 560 into the spindle interior 562.

The vent 521 includes the spacing 546 between the spacer 548 or spacer 300 and a tapered outer surface 550 of the spindle 502. The tapered outer surface 550 transitions between the smaller outer diameter outboard bearing journal 540 and the larger outer diameter inboard bearing journal 508. The opening 560 of the spindle 502 may be positioned inboard, up along the tapered outer surface 550 to keep oil away from the opening 560.

Uses of singular terms such as "a," "an," are intended to cover both the singular and the plural, unless otherwise indicated herein or clearly contradicted by context. The terms "comprising," "having," "including," and "containing" are to be construed as open-ended terms. It is intended that the phrase "at least one of" as used herein be interpreted in the disjunctive sense. For example, the phrase "at least one of A and B" is intended to encompass A, B, or both A and B.

While there have been illustrated and described particular embodiments of the present invention, it will be appreciated that numerous changes and modifications will occur to those skilled in the art, and it is intended for the present invention to cover all those changes and modifications which fall within the scope of the appended claims.

What is claimed is:

1. A wheel end system comprising:
a spindle having an interior and a side wall extending about the interior;
a wheel hub;
inboard and outboard bearings rotatably connecting the wheel hub to the spindle;
a spacer between the inboard and outboard bearings, the spacer extending about the spindle and having a spacing between the spacer and the spindle; and
an airflow opening of the side wall of the spindle having an inlet portion outboard of the inboard bearing, the airflow opening configured to permit air to travel from the spacing between the spacer and the spindle into the interior of the spindle.

2. The wheel end system of claim 1 wherein the inlet portion of the airflow opening opens to the spacing between the spacer and the spindle; wherein the airflow opening has an outlet portion that opens to the interior of the spindle.

3. The wheel end system of claim 1 wherein the inboard and outboard bearings each have a clearance fit with the spindle.

4. The wheel end system of claim 1 wherein the outboard bearing includes an outboard bearing cone having a fit with the spindle configured to permit air to travel between the outboard bearing cone and the spindle into the spacing between the spacer and the spindle.

5. The wheel end system of claim 4 wherein the spindle includes threads to receive a spindle nut assembly and a keyway to receive a key of the spindle nut assembly, the keyway configured to permit air to travel from the keyway into an interface between the outboard bearing cone and the spindle.

6. The wheel end system of claim 1 wherein the inlet portion of the airflow opening is at a top dead center of the spindle.

7. The wheel end system of claim 1 wherein the wheel hub has an interior to receive a lubricant; and
wherein the inlet portion of the airflow opening is at an upper portion of the spindle to permit gravity to draw lubricant that travels with the air into the spacing between the spacer and spindle away from the airflow opening.

8. The wheel end system of claim 1 wherein the side wall of the spindle has an annular outer surface portion and an annular inner surface portion, the annular inner surface portion defining at least a portion of the interior of the spindle; and
wherein the airflow opening extends between the annular outer and inner surface portions of the spindle.

9. The wheel end system of claim 1 wherein the spacer has an outboard end adjacent the outboard bearing, an inboard end adjacent the inboard bearing, and a side wall extending therebetween; and wherein the inlet portion of the airflow opening of the spindle is inboard of the outboard end of the spacer and spaced a predetermined distance along the spindle from the outboard end of the spacer to facilitate lubricant traveling with the air between the spacer and the spindle to travel away from the inlet portion of the airflow opening as the lubricant travels along the spindle.

10. The wheel end system of claim 9 wherein the spacer has an overall length extending between the outboard and inboard ends; and wherein the predetermined distance is at least a quarter of the overall length of the spacer.

11. The wheel end system of claim 9 wherein the inlet portion of the airflow opening is at a top dead center of the spindle.

12. The wheel end system of claim 1 wherein the spacer includes an outboard end portion, an inboard end portion, and a side wall extending therebetween; and wherein the spacer includes an opening extending radially through the side wall of the spacer to direct air into the spacing between the spacer and the spindle.

13. The wheel end system of claim 12 wherein the opening comprises at least two openings extending radially through the side wall of the spacer.

14. The wheel end system of claim 1 wherein the spindle is a tapered spindle and includes an inboard bearing journal for the inboard bearing and an outboard bearing journal for the outboard bearing, the inboard bearing journal having an outer diameter that is larger than an outer diameter of the outboard bearing journal.
